(19) United States
(12) Patent Application Publication
(10) Pub. No.: US 2026/0111961 A1
(43) Pub. Date: Apr. 23, 2026

(54) SYSTEM AND METHOD FOR A BACKTESTING MINIBROKER

(71) Applicant: FX Replay, Inc., Oklahoma City, OK (US)

(72) Inventors: Rodrigo A. Collao Benitez, Norman, OK (US); John H. Goocher, Davidson, NC (US); Aaron S. Rodriguez, Santa Cruz de la Sierra (BO)

(21) Appl. No.: 19/360,471

(22) Filed: Oct. 16, 2025

Related U.S. Application Data
(60) Provisional application No. 63/709,062, filed on Oct. 18, 2024.

(51) Int. Cl. G06Q 40/04

(52) U.S. Cl. CPC G06Q 40/042; G06Q 40/0431

(57) ABSTRACT

Disclosed herein is a backtesting system comprising a user device and a service device. The user device comprises a user memory storing instructions causing a processor to display a primary interface for backtesting session selection, communicate via an event-based communication session with the service device, requests and delta-decodes price data, store the delta-decoded price data in a client buffer, and render a backtesting chart based on a simulation time and the price data corresponding to the simulation time. The service device includes a service memory storing instructions that cause a service processor to establish the communication session, retrieve backtesting session data, select historical data for financial instruments based on the backtesting session data and store the historical data in a service buffer of price data, delta-encode the price data, and transmit the delta-encoded price data to the user device.

### CROSS-REFERENCE TO RELATED APPLICATIONS

This application claims priority to U.S. Provisional Patent Application No. 63/709,062, filed Oct. 18, 2024, the entire content of which is hereby incorporated herein by reference in its entirety.

### BACKGROUND

In the context of financial market analysis and strategy development, backtesting plays a crucial role in assessing the effectiveness and robustness of trading strategies. By simulating the application of a particular trading strategy on historical securities data, analysts and investors can gain valuable insights into how the particular trading strategy would have performed under various market conditions. However, traditional backtesting methodologies often overlook the significance of economic events and their impact on market dynamics.

The substantial data requirements for comprehensive backtesting pose significant challenges to system performance and efficiency. Traditional backtesting methodologies often require processing of vast amounts of historical financial data, including price movements, trading volumes, and various market indicators across multiple securities and timeframes. As the complexity of trading strategies increases and the desire for more granular analysis grows, the volume of data required for accurate backtesting expands exponentially. This data deluge can overwhelm conventional computing systems, leading to extended processing times and reduced operational efficiency. This latency results in a user experience characterized by noticeable lag for user devices and a failure to accurately simulate real-time trading.

In traditional backtesting architectures, the transmission of price data between a server storing historical market data and a user device presents a significant bottleneck. When a user requests historical data for a backtesting session, conventional systems typically either transmit the entire dataset upfront (resulting in long initial load times and excessive memory consumption on the user device) or repeatedly query the server as the simulation progresses (creating network congestion and server load that scales poorly as the simulation advances). Both approaches suffer from inefficiencies that degrade system responsiveness. The resulting delays in data availability directly undermine the efficiency of the backtesting simulation, as the system cannot faithfully replicate the immediacy and fluidity of actual market trading conditions where price information and order execution occur with minimal latency.

The performance bottleneck in backtesting systems is further exacerbated by the need for real-time or near-real-time analysis in modern trading environments. As financial markets become increasingly dynamic and interconnected, the ability to rapidly backtest and adjust strategies in response to changing market conditions becomes crucial. However, the sheer volume of data involved in comprehensive backtesting often conflicts with this need for speed. The calculations required to simulate complex trading strategies across extensive historical datasets can result in latency issues that may render the backtesting results less actionable in fast-moving markets. When the backtesting interface exhibits noticeable lag during simulation progression (such as when a user advances the simulation time forward), this lag creates an artificial delay that does not exist in real market trading, thereby reducing the fidelity of the simulation as a training and strategy evaluation tool. A trader practicing decision-making in a sluggish backtesting environment may develop timing habits and expectations that do not translate to actual market conditions where orders must be placed rapidly and market data updates continuously.

Therefore, a need exists for an improved backtesting system that addresses these limitations.

### SUMMARY

To address these limitations, including accurate simulation of a trading strategy on historic market instruments, there is a growing need for a backtesting solution that efficiently transmits and processes historical data between a service device and a user device to reduce latency on the user device while accurately and responsively viewing the historical data.

The system and method described herein provide a technical solution to the problem of accurately simulating historical market data in a backtesting session. Specifically, the backtesting system utilizes a dual-buffer arrangement between a user device and a service device that communicate using an event-based communication session. These solutions improve the accuracy and realism of the backtesting simulation.

Furthermore, the backtesting system efficiently manages and displays large amounts of price data. Rather than either transmitting entire datasets upfront or repeatedly querying the backtesting system for updated price data as the simulation time advances, the user device retrieves a delta-encoded buffer of price data from a service buffer of price data maintained by the service device. This arrangement provides improvements over traditional methods including reducing network traffic requirements, initial load times, and backtesting system computational load, while enabling responsive updates to the primary user interface of the user device. This arrangement further provides a decrease in memory requirements on both the user device and the service device. The result is a more efficient and performant backtesting system that can handle complex simulations with complex and numerous historical financial instruments, thereby improving the fidelity of the backtesting simulation.

The problem of accurately simulating historical market data in the backtesting session is solved by the systems and methods herein disclosed. The systems and methods include a backtesting system, comprising: a user device and a service device. The user device has an input device, an output device, a client processor, and a client memory. The client memory comprises a first non-transitory processor-readable medium storing processor-executable instructions that when executed by the client processor, cause the client processor to: display a primary user interface on the output device, the primary user interface operable to receive one or more input from the input device; receive an input from a user indicative of selection of a backtesting session, the backtesting session associated with backtesting session data, the backtesting data associated with at least one financial instrument; send an initialization signal to a service device to cause the service device to initialize an event-based communication session, the initialization signal including at least a user ID and a backtesting session ID; request buffer of price data for the at least one financial instrument, the buffer of price data having at least a buffer start timestamp, the price data for each financial instrument comprises at least a price timestamp and an instrument value; delta-decode the buffer of price data and store the buffer of price data in the client memory; and render, in a backtesting chart of the primary user interface, the price data for the at least one financial instrument corresponding to a simulation time. The service device comprises a service processor and a service memory. The service memory comprises a second non-transitory processor-readable medium storing processor-executable instructions that when executed by the service processor, cause the service processor to: establish the event-based communication session with the user device based on the initialization signal; retrieve backtesting session data based on the backtesting session ID of the initialization signal; select historical data for each financial instrument in the backtesting session and store the historical data in a memory buffer; in response to a request for the buffer of price data, delta-encode the buffer of price data based on the historical data for each financial instrument and the buffer start timestamp; and transmit the delta-encoded buffer of price data.

The systems and methods further include a backtesting system comprising a user device and a service device. The user device has an input device, an output device, a client processor, and a client memory. The client memory comprises a first non-transitory processor-readable medium storing a buffer of price data having a buffer timestamp, the price data comprising at least a price timestamp and an instrument value, and processor-executable instructions. The processor-executable instructions, when executed by the client processor, cause the client processor to: display a primary user interface on the output device for a backtesting session, the primary user interface operable to receive one or more input from the input device, the backtesting session having a first simulation time and a backtesting chart for a historical financial instrument; receive an input from the input device; increment the first simulation time to a second simulation time by a time increment and load the price data having a price timestamp within a range of the first simulation time and the second simulation time, and remove the loaded price data from the buffer of price data; emit an update-time event having the second simulation time as a parameter; and render, in a backtesting chart of the primary user interface, the loaded price data for the at least one financial instrument corresponding to the second simulation time. The service device comprises a service processor and a service memory. The service memory comprises a second non-transitory processor-readable medium storing a current session time for the backtesting session, a second buffer of the price data, a historical data database, and processor-executable instructions. The processor-executable instructions, when executed by the service processor, cause the service processor to: receive the update-time event having the second simulation time; update the current session time for the backtesting session to the second simulation time; and remove price data having respective price timestamps before the current session time.

The foregoing Summary provides an overview of certain selected implementations or embodiments disclosed herein, and is not intended to describe every aspect, embodiment, implementation, feature, or advantage of the disclosure exhaustively or comprehensively. Therefore, this Summary should not be construed in such a way to limit the scope of this disclosure or to limit the scope of the claims. The details of one or more implementation or embodiment disclosed herein are set forth in the accompanying drawings and descriptions below. Other aspects, features, implementations, embodiments, and advantages will become readily apparent in view of the description, the drawings, and the claims set forth herein.

Implementations of the above techniques include methods, apparatus, systems, and computer program products are described. One such computer program product is suitably embodied in a non-transitory computer-readable medium that stores instructions executable by one or more processors. The instructions are configured to cause the one or more processors to perform the above-described actions.

The details of one or more implementations of the subject matter of this specification are set forth in the accompanying drawings and the description below. Other aspects, features and advantages will become apparent from the description, the drawings, and the claims.

### BRIEF DESCRIPTION OF DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a diagram of an exemplary embodiment of hardware forming a system constructed in accordance with the present disclosure;

FIG. 2 is a diagram of an exemplary embodiment of a user device for use in the system of FIG. 1 constructed in accordance with the present disclosure;

FIG. 3 is a diagram of an exemplary embodiment of a backtesting system of the system of FIG. 1 constructed in accordance with the present disclosure;

FIG. 4A is a screenshot of an exemplary embodiment of the user device displaying a primary user interface with a backtesting dashboard constructed in accordance with the present disclosure;

FIG. 4B is a screenshot of an exemplary embodiment of the primary user interface displaying a backtesting session view at a first simulation time and constructed in accordance with the present disclosure;

FIG. 5 is a diagram of an exemplary embodiment of a session-service socket connection process constructed in accordance with the present disclosure;

FIG. 6A is a first diagram of an exemplary embodiment of a session-service update process constructed in accordance with the present disclosure; and

FIG. 6B is a second diagram of an exemplary embodiment of the session-service update process of FIG. 6A constructed in accordance with the present disclosure.

### DETAILED DESCRIPTION

Before explaining at least one embodiment of the disclosure in detail, it is to be understood that the disclosure is not limited in its application to the details of construction, experiments, exemplary data, and/or the arrangement of the components set forth in the following description or illustrated in the drawings unless otherwise noted. The disclosure is capable of other embodiments or of being practiced or carried out in various ways. Also, it is to be understood that the phraseology and terminology employed herein is for purposes of description and should not be regarded as limiting.

As used in the description herein, the terms “comprises,” “comprising,” “includes,” “including,” “has,” “having,” or any other variations thereof, are intended to cover a non-exclusive inclusion. For example, unless otherwise noted, a process, method, article, or apparatus that comprises a list of elements is not necessarily limited to only those elements but may also include other elements not expressly listed or inherent to such process, method, article, or apparatus.

Further, unless expressly stated to the contrary, “or” refers to an inclusive and not to an exclusive “or”. For example, a condition A or B is satisfied by one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise. Further, use of the term “plurality” is meant to convey “more than one” unless expressly stated to the contrary.

As used herein, qualifiers like “substantially,” “about,” “approximately,” and combinations and variations thereof, are intended to include not only the exact amount or value that they qualify, but also some slight deviations therefrom, which may be due to computing tolerances, computing error, manufacturing tolerances, measurement error, wear and tear, stresses exerted on various parts, and combinations thereof, for example.

As used herein, any reference to “one embodiment,” “an embodiment,” “some embodiments,” “one example,” “for example,” or “an example” means that a particular element, feature, structure, or characteristic described in connection with the embodiment is included in at least one embodiment and may be used in conjunction with other embodiments. The appearance of the phrase “in some embodiments” or “one example” in various places in the specification is not necessarily all referring to the same embodiment, for example.

The use of ordinal number terminology (i.e., “first”, “second”, “third”, “fourth”, etc.) is solely for the purpose of differentiating between two or more items and, unless explicitly stated otherwise, is not meant to imply any sequence or order of importance to one item over another.

The use of the term “at least one” or “one or more” will be understood to include one as well as any quantity more than one. In addition, the use of the phrase “at least one of X, Y, and Z” will be understood to include X alone, Y alone, and Z alone, as well as any combination of X, Y, and Z.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the disclosure as described herein. Where a range of numerical values is stated herein as being less than a stated value, the range is nevertheless bounded on its lower end by a non-zero value. It is not intended that the scope of the disclosure be limited to the specific values recited when defining a range. All ranges are inclusive and combinable.

Circuitry, as used herein, may be analog and/or digital components, or one or more suitably programmed processors (e.g., microprocessors) and associated hardware and software, or hardwired logic. Also, “components” may perform one or more functions. The term “processing component,” may include hardware, such as a processor (e.g., microprocessor), an application specific integrated circuit (ASIC), a field programmable gate array (FPGA), a combination of hardware and software, software, and/or the like. The term “processor” as used herein means a single processor or multiple processors working independently or together to collectively perform a task.

Software may include one or more computer readable instruction that when executed by one or more component, e.g., a processor, causes the component to perform a specified function. It should be understood that the algorithms described herein may be stored on one or more non-transitory computer-readable medium. Exemplary non-transitory computer-readable media may include a non-volatile memory, a volatile memory, a random-access memory (RAM), a read only memory (ROM), a CD-ROM, a hard drive, a solid-state drive, a flash drive, a memory card, a DVD-ROM, a Blu-ray Disk, a laser disk, a magnetic disk, an optical drive, phase change memory, combinations thereof, and/or the like. Such non-transitory computer-readable media may be electrically based, optically based, magnetically based, material-phase based, resistive based, and/or the like. Further, the messages described herein may be generated by the components and result in various physical transformations.

As used herein, the terms “network-based,” “cloud-based,” and any variations thereof, are intended to include the provision of configurable computational resources on demand via interfacing with a computer and/or computer network, with software and/or data at least partially located on a computer and/or computer network.

As used herein, the term “financial instrument” (also referred to herein as a “historic market instrument”) refers to a tradable asset or security that can be bought, sold, or exchanged in financial markets. Financial instruments may include, but are not limited to, equities such as stocks and shares in publicly traded companies, fixed-income securities such as bonds and treasury notes, currencies and foreign exchange pairs (e.g., United States Dollar (USD), Euro (EUR), British Pound (GBP), and/or the like), commodities such as precious metals (e.g., gold, silver, platinum), energy resources (e.g., crude oil, natural gas), and agricultural products (e.g., wheat, corn, soybeans), derivatives such as futures contracts and options, exchange-traded funds (ETFs), indices, cryptocurrency assets, and any other tradable asset or security available through financial markets. The term encompasses both individual instruments and pairs of instruments (e.g., currency pairs such as EUR/USD), where the relative value or exchange rate between two financial instruments forms the basis for trading analysis. Throughout this disclosure, the terms “financial instrument” and “historic market instrument” are used interchangeably and should be understood to have the same meaning, with “historic” referring to the fact that the financial instrument data being analyzed pertains to past market activity rather than real-time trading.

As used herein, the term ‘backtesting’ refers to a method used by investors, traders, and/or financial analysts to evaluate the potential performance of a trading strategy or investment model using historical data for one or more financial instruments. During backtesting, the trading strategy is applied to the historical data to ascertain how the trading strategy would have performed had it been implemented during a specified historical period of time. Backtesting involves simulating the historical data of the financial instrument as though the financial instrument was presently being traded, such as in the stock market. The user is provided with an ability to make simulated trades (e.g., opening and closing positions and placing orders such as limit and stop orders) against the historical data of the financial instrument in a simulation time (optionally, corresponding to the historical period of time for a market that has already closed). The user is further provided with an ability to analyze backtesting results to identify potential trends, risks, returns, and/or other performance metrics associated with the trading strategy. Thus, backtesting serves as a tool for refining trading strategies and for identifying potential strengths and weaknesses of those trading strategies before implementing the trading strategies in real-time trading. The historical data may include granular price data for the financial instrument, where each price datum includes at least a timestamp (indicating when a particular market transaction or price observation occurred) and a market value (indicating the price of the financial instrument at that timestamp).

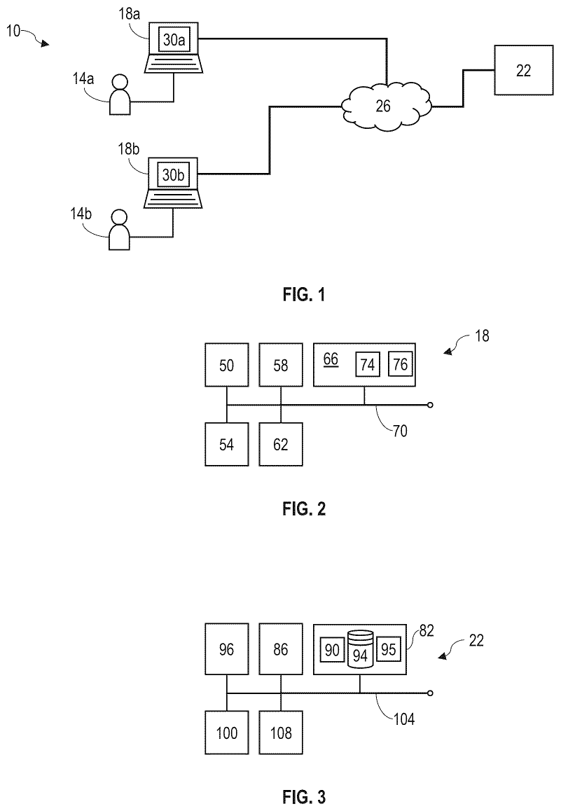

Referring now to the drawings, and in particular to FIG. 1, shown therein is a diagram of an exemplary embodiment of a backtesting system 10 constructed in accordance with the present disclosure. A plurality of users 14 (individually, user 14) may interact, i.e., via two way-communications, with the backtesting system 10 using a respective user device 18 that may be used to interact with a service device 22. Each user device 18 may communicate with the service device 22 via a network 26. In one embodiment, each user 14 may have a user profile associated with user settings that allows the particular user 14 to access the service device 22 via the particular user device 18 on which the particular user 14 is signed in. As shown in FIG. 1, a first user 14a may interact with a first user device 18a to access the service device 22 and a second user 14b may interact with a second user device 18b to access the service device 22.

In one embodiment, the first user 14a and the second user 14b may be the same user 14 and the first user device 18a and the second user device 18b may be the same user device 18, such that the same user 14 utilizes the same user device 18 to provide a first primary user interface 30a associated with a first backtesting session instance and a second primary user interface 30b associated with a second backtesting session instance. The first backtesting session instance and the second backtesting session instance may be different instances of the same backtesting session or, in some embodiments, may be instances of different backtesting sessions. Each backtesting session instance may have both a backtesting instance ID identifying a particular backtesting instance and a backtesting session ID identifying a particular backtesting session.

In another embodiment, the first user 14a and the second user 14b may be the same user 14 and the first user device 18a and the second user device 18b may be different user devices 18, such that the same user 14 utilizes the first user device 18a to provide a first primary user interface 30a associated with a first backtesting session instance and utilizes the second user device 18b to provide a second primary user interface 30b associated with a second backtesting session instance. The first backtesting session instance and the second backtesting session instance may be instances of the same backtesting session or, in some embodiments, may be instances of different backtesting sessions. Each backtesting session instance may have both a backtesting instance ID identifying a particular backtesting instance and a backtesting session ID identifying a particular backtesting session.

In some embodiments, the network 26 may be the Internet and/or other network. For example, if the network 26 is the Internet, a primary user interface 30 (described below in more detail) of the backtesting system 10 may be delivered through a series of web pages or private internal web pages of a company or corporation, which may be written in hypertext markup language (HTML/PHP/JavaScript), for example, and may be accessible by the user device 18. It should be noted that the primary user interface 30 of the backtesting system 10 may be another type of interface including, but not limited to, a Windows-based application, a server-based application, a tablet-based application, a mobile web interface, an application running on a mobile device, a virtual-reality interface, an augmented-reality interface, and/or the like.

The network 26 may be almost any type of network. For example, in some embodiments, the network 26 may be a version of an Internet network (e.g., exist in a UPD or TCP/IP-based network). In one embodiment, the network 26 is the Internet. It should be noted, however, that the network 26 may be almost any type of network and may be implemented as the World Wide Web (or Internet), a local area network (LAN), a wide area network (WAN), an LPWAN, a LoRa network, a metropolitan network, a wireless network, a WIFI network, a cellular network, a Bluetooth network, a Global System for Mobile Communications (GSM) network, a code division multiple access (CDMA) network, a 3G network, a 4G network, an LTE network, a 5G network, a satellite network, a radio network, an optical network, a cable network, a public switched telephone network, an Ethernet network, a short-wave wireless network, a long-wave wireless network, combinations thereof, and/or the like. It is conceivable that in the near future, embodiments of the present disclosure may use more advanced networking topologies.

The number of devices and/or networks illustrated in FIG. 1 is provided for explanatory purposes. In practice, there may be additional devices and/or networks, fewer devices and/or networks, different devices and/or networks, or differently arranged devices and/or networks than are shown in FIG. 1. Furthermore, two or more of the devices illustrated in FIG. 1 may be implemented within a single device, or a single device illustrated in FIG. 1 may be implemented as multiple, distributed devices. Additionally, or alternatively, one or more of the devices of backtesting system 10 may perform one or more functions described as being performed by another one or more of the devices of the backtesting system 10. Devices of the backtesting system 10 may interconnect via wired connections, wireless connections, or a combination thereof.

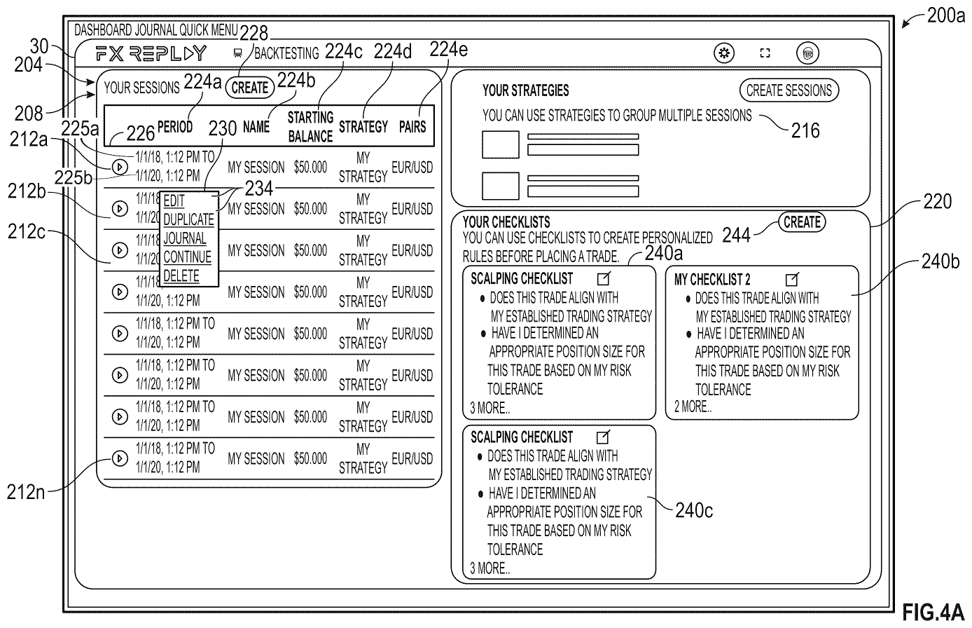

Referring now to FIG. 2, shown therein is a diagram of an exemplary embodiment of the user device 18 of the backtesting system 10 constructed in accordance with the present disclosure. In some embodiments, the user device 18 may include, but is not limited to, implementations as a personal computer, a cellular telephone, a smart phone, a network-capable television set, a tablet, a laptop computer, a desktop computer, a network-capable handheld device, a server, a digital video recorder, a wearable network-capable device, a virtual reality/augmented reality device, and/or the like. Each user device 18 of the backtesting system 10, e.g., the first user device 18a and the second user device 18b, may be constructed in accordance with the user device 18 as described herein.

In some embodiments, the user device 18 may include one or more input device 50 (hereinafter “input device 50”), one or more output device 54 (hereinafter “output device 54”), one or more client processor 58 (hereinafter “client processor 58”), one or more communication device 62 (hereinafter “communication device 62”) capable of interfacing with the network 26, one or more client memory 66 (hereinafter “client memory 66”) storing processor-executable code and/or user application(s) 74 (hereinafter “user application 74”). The user application 74 may include, for example, a web browser capable of accessing a website and/or communicating information and/or data over a wireless or wired network (e.g., the network 26), and/or the like. The input device 50, output device 54, client processor 58, communication device 62, and client memory 66 may be connected via a path 70 such as a data bus that permits communication among the components of user device 18.

The client processor 58 may be implemented as a single processor or multiple processors working together, or independently, to execute the user application 74 as described herein. It is to be understood, that in certain embodiments using more than one client processor 58, the client processors 58 may be located remotely from one another, located in the same location, or comprising a unitary multi-core processor. The client processors 58 may be capable of reading and/or executing processor-executable code and/or capable of creating, manipulating, retrieving, altering, and/or storing data structures into the client memory 66.

Exemplary embodiments of the client processor 58 may include, but are not limited to, a digital signal processor (DSP), a central processing unit (CPU), a field programmable gate array (FPGA), a graphics processing unit (GPU), a neural processing unit (NPU), a microprocessor, a multi-core processor, an application specific integrated circuit (ASIC), combinations thereof, and/or the like, for example. The client processor 58 may be capable of communicating with the client memory 66 via the path 70 (e.g., data bus). The client processor 58 may be capable of communicating with the input device 50 and/or the output device 54. The client processor 58 may include one or more client processor 58 working together, or independently, and located locally, or remotely, e.g., accessible via the network 26.

The client memory 66 may be one or more non-transitory processor-readable medium. The client memory 66 may store the user application 74 that, when executed by the client processor 58, causes the user device 18 to perform an action such as communicate with or control one or more component of the user device 18 and/or, via the network 26, the service device 22. The client memory 66 may be one or more client memory 66 working together, or independently, to store processor-executable code and may be located locally or remotely, e.g., accessible via the network 26. In one embodiment, the client memory 66 may further comprise a client buffer 76 of price data as described in more detail below.

The input device 50 may be capable of receiving information input from the user 14 and/or client processor 58, and transmitting such information to other components of the user device 18 and/or the network 26. The input device 50 may include, but is not limited to, implementation as a keyboard, a touchscreen, a mouse, a trackball, a microphone, a camera, a fingerprint reader, an infrared port, an optical port, a cell phone, a smart phone, a PDA, a remote control, a fax machine, a wearable communication device, a network interface, combinations thereof, and/or the like, for example. The input device 50 may include the primary user interface 30 on the user device 18.

The output device 54 may be capable of outputting information in a form perceivable by the user 14 and/or client processor 58. Implementations of the output device 54 may include, but are not limited to, a computer monitor, a screen, a touchscreen, a speaker, a website, a television set, a smart phone, a PDA, a cell phone, a fax machine, a printer, a laptop computer, a haptic feedback generator, an olfactory generator, combinations thereof, and the like, for example. The output device 54 may display the primary user interface 30 on the user device 18.

It is to be understood that in some exemplary embodiments, the input device 50 and the output device 54 may be implemented as a single device, such as, for example, a touchscreen of a computer, a tablet, or a smartphone. It is to be further understood that as used herein the term user (e.g., the user 14) is not limited to a human being, and may comprise a computer, a server, a website, a processor, a network interface, a user terminal, a virtual computer, combinations thereof, and/or the like, for example.

The communication device 62, in communication with the client processor 58, may interface with the network 26. The network 26 may permit bi-directional communication of information and/or data between the user device 18 and/or the service device 22. The network 26 may interface with the service device 22 and/or the user device 18 in a variety of ways. For example, in some embodiments, the network 26 may interface by optical and/or electronic interfaces, and/or may use a plurality of network topographies and/or protocols including, but not limited to, Ethernet, UDP/TCP/IP, circuit switched path, combinations thereof, and/or the like, as described above. For example, the client processor 58 may be capable of communicating via the network 26 by exchanging signals (e.g., analog, digital, optical, and/or the like) via one or more port (e.g., physical or virtual ports) using a network protocol to provide updated information to the service device 22 (e.g., to a backtesting application 90 (described below) executed on the service device 22).

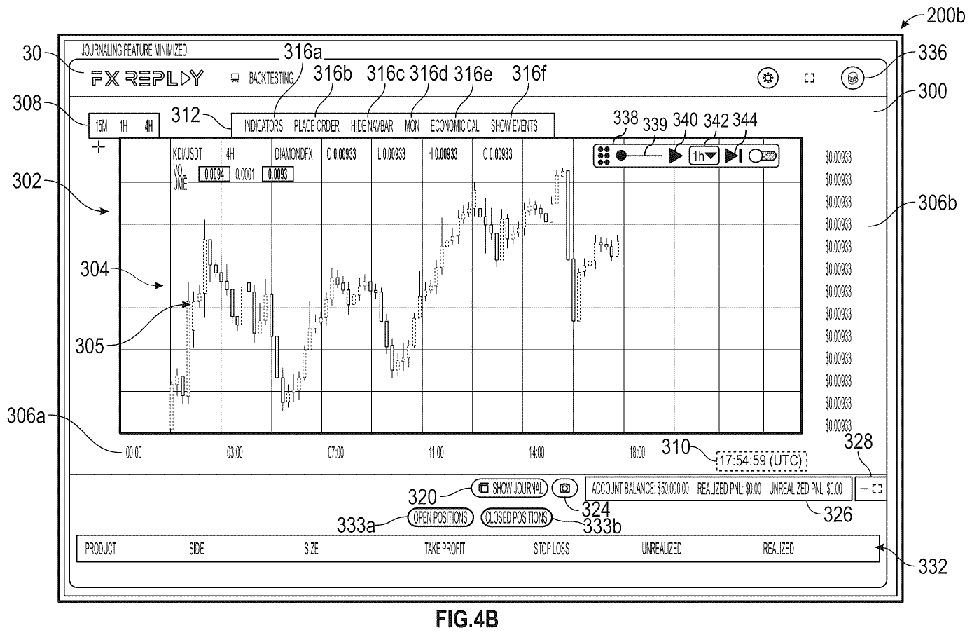

Referring now to FIG. 3, shown therein is a diagram of an exemplary embodiment of the service device 22 constructed in accordance with the present disclosure. The service device 22 may include one or more device that execute(s) one or more application or service in a manner described herein. In the illustrated embodiment, the service device 22 is provided with a service memory 82 (hereinafter “service memory 82”) accessible by one or more service processor 86 (hereinafter “service processor 86”). The service memory 82 may include one or more non-transitory processor-readable medium storing processor-executable code and/or software application(s) 90 (hereinafter “backtesting application 90”) and one or more database 94 (hereinafter “database 94”).

The service memory 82 may further store, for example, the historical data for a plurality of market instruments. In some embodiments, the historical data may be stored, for example, in the database 94. In one embodiment, the service memory 82 may further comprise a service buffer 95 of price data (e.g., a cache). In some embodiments, the service memory 82 may store the service buffer 95 for each backtesting session being executed by users 14 on the service device 22. For example, the first user 14a may use the first user device 18a to execute a first backtesting session and connect to the service device 22 causing the service device 22 to generate a first service buffer for the first backtesting session and the second user 14b may use the second user device 18b to execute a second backtesting session and connect to the service device 22 causing the service device 22 to generate a second service buffer for the second backtesting session. In some embodiments, the service buffer 95 may be stored in an in-memory datastore/database. Exemplary in-memory datastores may include, for example, REDIS® (Redis Ltd., San Francisco, CA, USA).

In some embodiments, the service device 22 may comprise the one or more service processor 86 working together, or independently to, execute processor-executable code, such as the backtesting application 90, stored on the service memory 82. Additionally, the service device 22 may include at least one input device 96 (hereinafter “input device 96”) and at least one output device 100 (hereinafter “output device 100”). Each element of the service device 22 may be partially or completely network-based or cloud-based, and may or may not be located in a single physical location.

The service processor 86 may be implemented as a single processor or multiple processors working together, or independently, to execute the backtesting application 90 as described herein. It is to be understood, that in certain embodiments using more than one service processor 86, the service processor 86 may be located remotely from one another, located in the same location, or comprising a unitary multi-core processor. The service processor 86 may be capable of reading and/or executing processor-executable code and/or capable of creating, manipulating, retrieving, altering, and/or storing data structures into the service memory 82 such as in the database 94.

Exemplary embodiments of the service processor 86 may be constructed similar to and in accordance with the client processor 58 described above in more detail. The service processor 86 may be capable of communicating with the service memory 82 via a path 104 (e.g., data bus). The service processor 86 may be capable of communicating with the input device 96 and/or the output device 100.

The service processor 86 may be further capable of interfacing and/or communicating with the user device 18 via the network 26 using a communication device 108. For example, the service processor 86 may be capable of communicating via the network 26 by exchanging signals (e.g., analog, digital, optical, and/or the like) via one or more port (e.g., physical or virtual ports) using a network protocol to provide updated information to the user application 74 or the primary user interface 30 executed on the user device 18.

In some embodiments, the service memory 82 may be located in the same physical location as the service device 22, and/or one or more service memory 82 may be located remotely from the service device 22. For example, the service memory 82 may be located remotely from the service device 22 and communicate with the service processor 86 via the network 26. Additionally, when more than one service memory 82 is used, a first service memory 82 may be located in the same physical location as the service processor 86, and additional service memory 82 may be located in a location physically remote from the service processor 86. Additionally, the service memory 82 may be implemented as a “cloud” non-transitory processor-readable medium (i.e., one or more service memory 82 may be partially or completely based on or accessed using the network 26).

The service memory 82 may store processor-executable code and/or information comprising the database 94 and the backtesting application 90. In some embodiments, the backtesting application 90 may be stored as a compiled application file, such as an executable file, for example, or in a structure (or unstructured) format, such as, e.g., in a non-compiled file. The backtesting application 90 may include one or more module of processor-executable code. For example, the backtesting application 90 may include a session module 90a and an order module 90b, as described below.

In one embodiment, the database 94 can be a relational database, a time-series database, a vector database, a non-relational database, a document database, and/or the like, or combinations thereof. Examples of such databases comprise, DB2®, Microsoft® Access, Microsoft® SQL Server, Oracle®, MySQL, PostgreSQL, MongoDB, Apache Cassandra, Weaviate, REDIS®, and the like. It should be understood that these examples have been provided for the purposes of illustration only and should not be construed as limiting the presently disclosed inventive concepts. The database 94 can be centralized or distributed across multiple systems. For example, the database 94 may include a first database 94a storing user data and/or backtesting session data (described below) and a second database 94b storing the historical data, e.g., as a historical data database.

The input device 96 of the service device 22 may transmit data to the service processor 86 and may be constructed in accordance with or similar to the input device 50 of the user device 18 described above in more detail. The input device 96 may be located in the same physical location as the service processor 86, or located remotely and/or partially or completely network-based. The output device 100 of the service device 22 may transmit information from the service processor 86 to the user 14, and may be similar to the output device 54 of the user device 18. The output device 100 may be located with the service processor 86, or located remotely and/or partially or completely network-based.

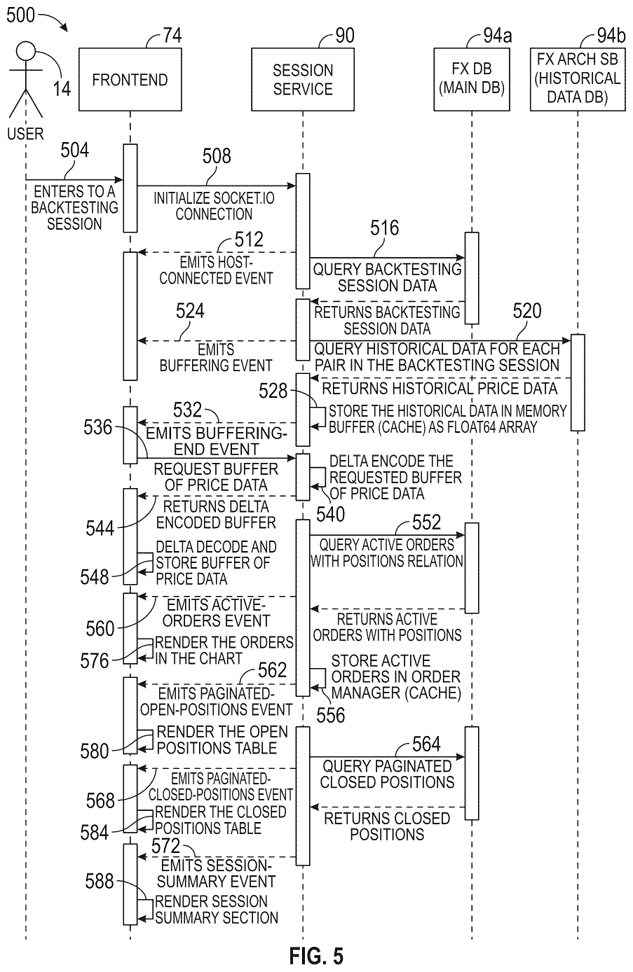

Referring now to FIG. 4A, shown therein is a screenshot 200a of an exemplary embodiment of the user device 18 displaying the primary user interface 30 with a backtesting dashboard 204 constructed in accordance with the present disclosure. As shown by the screenshot 200a, the client processor 58 may display the primary user interface 30 of the backtesting application 90 on the user device 18 to display a backtesting session list 208 having one or more backtesting item 212a-n associated with a particular backtesting session, a strategy group 216, and a checklist group 220.

In one embodiment, the backtesting dashboard 204 may be generated by the service processor 86 and may be transmitted by the service processor 86 to the client processor 58 via the network 26. For example, the backtesting dashboard 204 may be a series of web pages or a web application that is generated by the service processor 86 and displayed on the primary user interface 30 on the output device 54 of the user device 18 by the client processor 58, such as by rendering a webpage of the primary user interface 30 using a predetermined computer language, e.g., hypertext markup language (HTML/PHP/JavaScript), for example.

The backtesting session list 208 may display a list of one or more of the backtesting items 212, for which each backtesting item 212 may be associated with a particular backtesting session having backtesting session data. The backtesting session list 208 may display the list of all backtesting items 212 for the user, or, in other embodiments, may display a list of a subset of the backtesting items 212 for the user. In one embodiment, the backtesting items 212 associated with particular backtesting sessions having backtesting session data may be stored in the service memory 82, such as in the database 94. The service processor 86 may transmit selected ones of the backtesting items 212 to the user device 18. The client processor 58 of the user device 18 may receive the transmitted backtesting items 212 and may store the backtesting items 212 in the client memory 66 and/or may display the list of the one or more of the backtesting items 212 on the output device 54.

As shown in FIG. 4A, each backtesting item 212 includes one or more backtesting property label 224 corresponding to a respective backtesting property, for example, shown as a period label 224a, a name label 224b, a starting balance label 224c, a strategy label 224d, and a pairs label 224e. In other embodiments, additional backtesting property labels 224 may be provided. Each backtesting property label 224 may correspond to a particular backtesting property of the backtesting session. The period label 224a may be a simulation timeframe (the historical time period, having a start simulation time 225a and an end simulation time 225b) that a particular backtesting session includes or is executed over, which corresponds to a historic date/time of the historic market instrument. The name label 224b may be a name of the particular backtesting session. The starting balance label 224c may be a starting balance of the particular backtesting session. The strategy label 224d may correspond to a strategy name of a particular strategy in the strategy group 216. The pairs label 224e may refer to any financial instrument or asset available within the particular backtesting session and may correspond to the historic market instrument being examined as part of the particular backtesting session. For example, the pair of instruments may encompass two or more assets, such as one or more financial instruments. The one or more financial instruments may include, for example, stocks, bonds, currency (e.g., United States Dollar (USD), Euro (EUR), and the like), commodities (e.g., gold and silver), and/or any other tradable asset. While each backtesting item 212 is shown with a currency pair associated with the pairs label 224e (e.g., shown with EUR/USD), the pairs are not limited to currency pairs alone and may encompass a wide range of assets or financial instruments that the user desires to analyze.

In one embodiment, each of the one or more backtesting properties are included in the backtesting session data and correspond to the backtesting property labels 224 for the associated backtesting session stored in the service memory 82, such as in the database 94, and may be associated with the particular backtesting session and the particular user 14, such as by linking a user ID and a backtesting session ID. The one or more backtesting properties in the backtesting session data may further include, for example, the backtesting session ID, a calculate fees option (set by the user 14), historic market instrument data (e.g., the historical data for the historic market instrument or financial instrument), an association to the user 14, a simulation timeframe, a current session time, and/or the like, for example. The backtesting session data for the backtesting session may further include a session manager (e.g., an identifier of a particular backtesting session instance such as the backtesting instance ID). In some embodiments, the backtesting session data further includes a connected instances property identifying each backtesting session instance connected to, and interacting with, the backtesting session.

By identifying the session manager, the backtesting session may support multiplayer backtesting sessions such that all players (e.g., users 14) may have a synchronized simulation time 310 (with the simulation time 310 of the session manager being the controlling simulation time for the backtesting session, stored and transmitted by the service device 22 as the current session time). Further, orders and positions for each user 14 may be executed independently of the orders/positions of other users 14. In some embodiments, the primary user interface 30 does not display orders/positions of other users 14; however, in other embodiments, the primary user interface 30 may display an indicator of orders/positions of other users 14. The indicator may be, for example, provided as an icon within the chart 302 on the primary user interface 30, the icon only indicating that an order/position has been taken by another user 14. In other embodiments, the indicator may be, for example, an indicator showing properties of the order/position the other user 14 has taken. In some embodiments, the indicator may be provided on the primary user interface 30 such that the indicator does not obscure the graph 304.

In one embodiment, each backtesting item 212 includes a view input 226. The service processor 86 may receive one or more input from the user device 18 indicative of selection of the view input 226 of a particular backtesting item 212 by the user, and, responsive to the selection, may cause the primary user interface 30 to load the associated backtesting session of the particular backtesting item 212. For example, the service processor 86, responsive to one or more input, e.g., from the user device 18, may cause the client processor 58 to update the primary user interface 30 to display a backtesting session view 300 (shown in FIG. 4B) and to load the backtesting session view 300 with backtesting session data of the associated backtesting session received from the service processor 86.

In one embodiment, the service processor 86 may receive one or more input from the user device 18 indicative of the user selecting a create input 228. Responsive to the selection of the create input 228, the service processor 86 may generate a new backtesting session.

In one embodiment, the service processor 86 may generate a backtesting item context menu 230 (FIG. 4A) responsive to receiving an input from the user via the user device 18. For example, if the user right-clicks (or hold-clicks) a particular backtesting item 212, the service processor 86 may generate the backtesting item context menu 230 having one or more context menu operations 234 operable to, upon selection by the user via the user device 18, cause the service processor 86 to execute a particular function against the backtesting session associated with the particular backtesting item 212. In one embodiment, the one or more context menu operations 234 include operations that when executed by the service processor 86 may cause the service processor 86 to: edit the backtesting session; duplicate the backtesting session; view the journal of the backtesting session; continue the backtesting session; and delete the backtesting session. For example, upon selection of the “Continue” context menu operation 234, the service processor 86, responsive to the selection, e.g., from the user device 18, may cause the primary user interface 30 to display the backtesting session view 300 (shown in FIG. 4B) loaded with backtesting session data of the backtesting session associated with the particular backtesting item 212.

In one embodiment, the backtesting dashboard 204 may further include the strategy group 216. The strategy group 216 may include one or more session collection having a strategy name and associated with one or more backtesting session. In one embodiment, the one or more backtesting session is mutually exclusive between session collections, that is, each backtesting session can only be associated with one session collection. In other embodiments, each backtesting session can be associated with more than one session collection. As shown, each backtesting item 212 may display the strategy label 224d comprising the strategy name of the session collection of which the backtesting session associated with the backtesting item 212 is a member.

In one embodiment, the backtesting dashboard 204 may further include the checklist group 220. The checklist group 220 may display one or more checklist 240a-n (shown as a first checklist 240a, a second checklist 240b, and a third checklist 240c). Each checklist 240 may be created and customized by the user. In one embodiment, the checklist 240 may be used as a reminder of one or more step that the user has identified as important to follow before the user places an order. Upon selection of a particular checklist 240, the service processor 86 may prompt the user to update or edit the particular checklist 240. In one embodiment, the checklist group 220 may further comprise a new checklist input 244. The service processor 86, responsive to the user selecting the new checklist input 244 may generate a checklist dialog.

Referring now to FIG. 4B, shown therein is a screenshot 200b of an exemplary embodiment of the user device 18 displaying the primary user interface 30 with a backtesting session view 300 displayed in accordance with the present disclosure. Generally, the backtesting session view 300 displays information of a backtesting session, such as the backtesting session associated with a particular backtesting item 212 selected by the user 14 from the backtesting dashboard 204.

As shown, the backtesting session view 300 includes a chart 302 having a graph 304, such as a candlestick line graph, showing a value of a historic market instrument 305 (e.g., historical data for a stock, financial market, or foreign exchange market that is at least one market-day old, or from a prior market-day) and having an axis of abscissas 306a showing time values within a chart timeframe, and an axis of ordinates 306b showing an instrument value. The backtesting session view 300 provides the user with a time granularity input 308 for selecting a time granularity. The time granularity determines a ticker timeframe represented by each ticker step (candlestick as shown in FIG. 4B) of the graph 304, where the ticker timeframe is the period of time for which each candlestick of the graph 304 of the historic market instrument 305 pertains.

While the time granularity input 308 is shown as having values of 15 min, 1 hour, and 4 hours, it should be understood that other time granularities of the ticker step may be selectable by the user, for example, the time granularity input 308 may have options including, but not limited to, 1 second, 5 seconds, 15 seconds, 30 seconds, 1 minute, 5 minutes, 15 minutes, 30 minutes, 1 hours, 4 hours, 8 hours, 12 hours, 1 day, 7 days, 1 week, 1 month, 1 year, and/or the like, or any value therebetween in 1 second increments. Upon receiving an indication of selection of a particular value of the time granularity input 308 by the user 14, the client processor 58 may store the particular value as the time granularity of the graph 304 in the backtesting session data.

In one embodiment, the historic market instrument 305 may be, for example, a time-series data having the market value associated with a particular time value (e.g., timestamp). The historic market instrument 305 may be provided with time granularity within the graph 304 where the time granularity is a time delta between consecutive market values in the time-series data. For example, the historic market instrument 305 may have a time granularity of 5 minutes, resulting in the time-series data providing instrument values in 5-minute increments. As described below in more detail, the service processor 86 may generate the service buffer 95 of price data and transmit at least a portion of the service buffer 95 to the client processor 58 to cause the client processor 58 to store the received portion of the service buffer 95 with the client buffer 76 of price data.

In one embodiment, the service processor 86 may retrieve the value of the historic market instrument 305 from the service memory 82, such as from the database 94. In one embodiment, the database 94 storing the instrument values is a non-relational database and/or a time-series database. The market value of the historic market instrument 305 may be, for example, stored as highly granular time-series data with a, e.g., per-tick granularity.

In one embodiment, the graph 304 may show instrument values for the historic market instrument 305 that have a time value at, or before, a simulation time 310. For example, as shown in FIG. 4B, the simulation time 310 is shown as “17:54:59 (UTC)” and the primary user interface 30 with the backtesting session view 300 loaded with backtesting session data of the associated backtesting session may show the market values for the historic market instrument 305 only up to the market values having a time value at or before the simulation time 310 of 17:54:59 (UTC), and may not, for example, display the market values having the time value greater than the simulation time 310. As used herein, reference to “prior market value”, or the like, refers to market values of the historic market instrument 305 prior to the simulation time 310 and within a chart timeframe of the chart 302. The chart timeframe of the chart 302 may be a period of time currently displayed on the chart 302, representing a subset of the simulation timeframe.

Further, it should be understood that while the graph 304 only shows market values of the historic market instrument 305 having the time value up to and including the simulation time 310, the simulation data of the associated backtesting session may include the time-series data of the historic market instrument 305 stored in the client buffer 76 of the price data having a respective timestamp exceeding, or after, the simulation time 310. In some embodiments, the simulation data may include the time-series data of the historic market instrument 305 of the price data having a respective timestamp within the chart timeframe or, in other embodiments, within the simulation timeframe.

The backtesting session view 300 further provides an option menu 312 having one or more option 316a-n, shown as options 316a-g. In one embodiment, the option menu 312 may include an indicator option 316a, a place order option 316b, a hide navbar option 316c, a day option 316d (shown as ‘Mon’ indicating ‘Monday’), an economic calendar option 316e, an events option 316f (shown as ‘Show Events’), and a Goto option 316g. In one embodiment, the indicator option 316a, when selected by the user, causes the client processor 58 to display one or more indicators on the chart 302. In one embodiment, the place order option 316b, when selected by the user, causes the client processor 58 to display a place order dialog on the primary user interface 30. In one embodiment, the hide navbar option 316c, when selected by the user, causes the client processor 58 to hide the option menu 312 from the display on the chart 302. In one embodiment, the day option 316d, when selected by the user, causes the client processor 58 to toggle a “day of week” modal, e.g., when a cursor is within the chart 302 or over the graph 304 of the historic market instrument 305.

In one embodiment, the events option 316f, when selected by the user, causes the client processor 58 to toggle display of one or more event icon associated with the economic calendar on the chart 302 as described in U.S. application Ser. No. 19/329,334 entitled “System and Method for Backtesting Economic Calendar” filed on Sep. 15, 2025, the entire content of which is hereby incorporated herein by reference in its entirety. In some embodiments, a text of the events option may change based on whether the one or more event icons are displayed on the chart 302. For example, if the one or more event icons are displayed on the chart 302, the text of the events option 316f may be “Hide Events” to indicate to the user 14 that selection of the events option 316f when the one or more event icons are displayed on the chart 302 will cause the client processor 58 to remove the one or more event icons from the chart 302. If the one or more event icons are not displayed on the chart 302, the text of the events option 316f may be “Show Events” to indicate to the user 14 that selection of the events option 316f when the one or more event icons are not displayed on the chart 302 will cause the client processor 58 to draw the one or more event icons onto the chart 302.

In one embodiment, the Goto option 316g, when selected by the user, causes the client processor 58 to display a Goto menu having one or more Goto jumps on the primary user interface 30 as described in U.S. application Ser. No. 19/183,609 entitled “System and Method for Selection of Backtesting Time and Region” filed on Apr. 18, 2025, the entire content of which is hereby incorporated herein by reference in its entirety.

In one embodiment, the backtesting session view 300 includes a show journal input 320 operable to cause the client processor 58 to display a one or more journal entry or journal screenshot as described in U.S. Pat. No. 12,307,527 entitled “Security Trading Backtesting System Having an Interactable Journal” issued on May 20, 2025, the entire content of which is hereby incorporated herein by reference in its entirety.

In one embodiment, the backtesting session view 300 may further include a session-summary section 326 showing an account balance for the backtesting session, a realized profit and loss for the backtesting session, and an unrealized profit and loss for the backtesting session.

In one embodiment, the backtesting session view 300 may further include a display setting selector 328 operable to, when selected by the user via the primary user interface 30, cause the client processor 58 to modify a display size of the chart 302.

In one embodiment, the backtesting session view 300 may further display one or more position, such as an open position or a closed position, in a positions table 332 (e.g., as an open positions table, a closed positions table, or a positions table having both open and closed positions). The positions table 332 may include rows of positions the user 14 has taken within the backtesting session. The positions may be shown, for example, as a row in the positions table 332, however, the positions may be shown in other formats as well. The positions may include one or more position property, a selection of which may be displayed as columns of the positions table 332, such as a product value, a side value, a size value, a take profit value, a stop loss value, an unrealized gain value, and a realized gain value. As show, the positions table 332 may display open positions upon selection of an open positions input 333a (shown as selected in FIG. 4B) and may display closed positions upon selection of a closed positions input 333b (shown as unselected in FIG. 4B).

In one embodiment, the backtesting session view 300 may further display a play menu 338 having a speed controller 339, a play button 340, an increment selector 342, and a skip-forward button 344. Upon receiving an indication of a selection of an increment value within the increment selector 342, the client processor 58 may store the selected increment value with the backtesting session data. Further, the client processor 58 may receive an input indicative of selection of the play button 340 causing the session time of the backtesting session to increment by the increment value at a rate corresponding to a select rate on the speed controller 339. The skip-forward button 344 may cause the simulation time 310 to advance by the increment value. In one embodiment, the play menu 338 is only displayed on the primary user interface 30 if the backtesting instance ID of the particular backtesting session in the primary user interface 30 is the session manager of the backtesting session.

In one embodiment, the backtesting session view 300 may further include a user settings menu 336 operable to display, on the primary user interface 30, an icon associated with a logged-in user account for the user 14 and a settings menu. The user's user account may include account information, such as a user's name, an email address, a username, a user ID, custom settings, account properties, calendar settings, and/or the like.

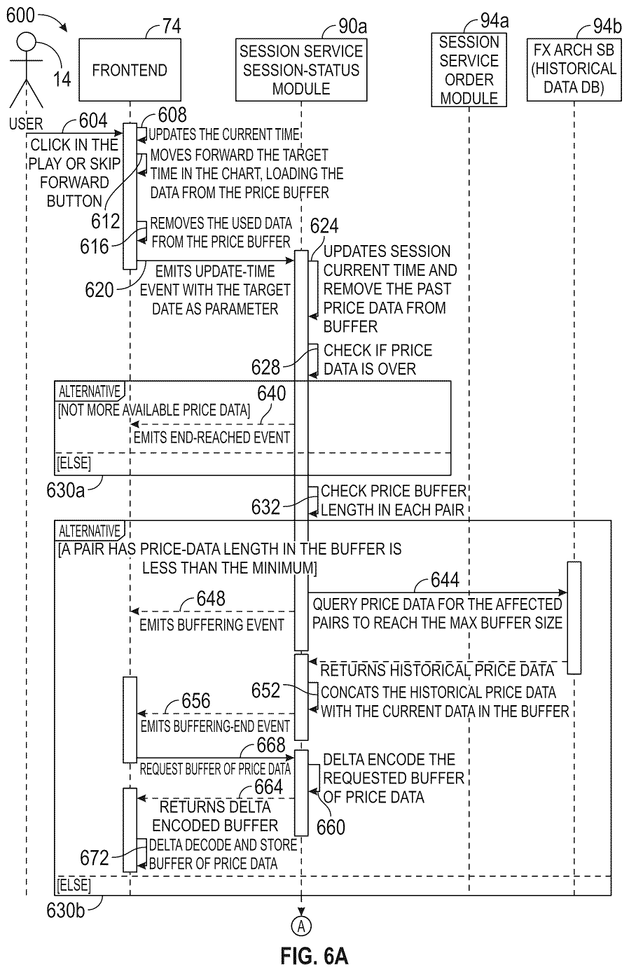

Referring now to FIG. 5, shown therein is a diagram of an exemplary embodiment of a session-service socket connection process 500 constructed in accordance with the present disclosure. As shown in FIG. 5, when the user 14 enters a backtesting session (step 504), such as by selection of the view input 226 of the particular backtesting item 212 by the user 14 (described above), the client processor 58 of the user device 18 executing the user application 74 may send an initialization signal 508 to the service device 22 to cause the service device 22 to initialize an event-based communication session. The initialization signal 508 may include, for example, at least account information, such as a user ID, and a backtesting session ID. The initialization signal 508 may further include a backtesting instance ID to identify a particular backtesting instance of the backtesting session. In some embodiments, if no other backtesting instance ID are associated with the backtesting session, then the backtesting instance ID may be provided as the session manager of the backtesting session. In some embodiments, the event-based communication session may utilize web socket communication via the network 26. In other embodiments, the event-based communication session may be, for example, a gRPC session.

In response to receiving the initialization signal 508, the service processor 86, executing the backtesting application 90, such as the session module 90a and/or the order module 90b, may establish the event-based communication session with the user device 18 based on the initialization signal 508 and may, in some embodiments, emit a host-connected event 512. The service processor 86 may then query backtesting session data (event 516), e.g., retrieve the backtesting session data for the backtesting session based on one or more of the backtesting session ID and the account information, from the service memory 82, such as from the database 94.

After retrieving the backtesting session data, the service processor 86 may select historical data for each financial instrument in the backtesting session (event 520). In some embodiments, the service processor 86 may emit a buffering event 524, e.g., simultaneously with the selection of the historical data.

After selection of the historical data, the service processor 86 may iterate through the historical data for each financial instrument to generate the price data stored in the service buffer 95 (step 528). The price data may be stored in the service buffer 95, for example, as a Float64 array. The price data stored in the service buffer 95 may be based on a buffer type (e.g., a second-type buffer or a minute-type buffer) of the service buffer 95. For example, the service buffer 95 may be a second-type buffer if one or more of: the time granularity value of the time granularity input 308 or increment value of the increment selector 342, have a value within a second-range, e.g., a value below 1 minute. The service buffer 95 may be a minute-type buffer if the time granularity value of the time granularity input 308 is 1 minute or greater. The buffer type may be associated with, or may be included as part of, the backtesting session data.

When the service processor 86 has completed parsing the historical data into the service buffer 95, or when the service buffer 95 has reached a predetermined maximum buffer length of price data, the service processor 86 may emit a buffering-end event 532. In some embodiments, the predetermined maximum buffer length may be based, for example, on the buffer duration. For example, the predetermined maximum buffer length may be time based, such that the buffer holds price data having timestamps spanning a period of time, such as two weeks. Alternatively, the predetermined maximum buffer length may be quantity based, such that the buffer holds a maximum quantity of price data (e.g., having timestamps after the simulation time 310 as described below).

In response to receiving the buffering-end event 532, the client processor 58 of the user device 18 may request a buffer of price data for the financial instrument of the backtesting session (step 536). The buffer of price data may include at least a buffer start timestamp and, e.g., an array of, the price data for each financial instrument. Each price datum in the array of price data may be referred to as a record of price data. The array of the price data may include a value timestamp and a market value and may be, for example, an ordered array of the price data based on the value timestamp. The buffer start timestamp may be a first value timestamp of the ordered array of the price data. The buffer start timestamp may be after the simulation time, for example, 1 second after the simulation time for a second-type buffer or 1 minute after the simulation time for a minute-type buffer.

The service processor 86 may delta-encode at least a portion of the service buffer 95 of price data (step 540) and return the delta-encoded buffer of price data (step 544). The service processor 86 may delta-encode at least a portion of the service buffer 95 of price data (step 540) by selecting a first price data as a key price data having a key value timestamp and key market value and, for each remaining price data of the array of the price data, may determine a delta price data comprising a delta time and a delta value. In this way, the delta-encoded buffer of price data may include the first price data of the array of price data and a respective delta price data for remaining price data in the array of price data. In one embodiment, for the second-type buffer, the delta time may be as small as one second while for the minute-type buffer, the delta time may be as small as one minute. Thus, when the graph 304 does not show increment values in time increments under 1 minute, the delta-encoded buffer of price data may not include delta price data for the financial instrument at delta times less than 1 minute apart. By utilizing the delta-encoded buffer of price data, the service device 22 achieves benefits over traditional methods, such as increased flexibility, faster load times, and smaller network and memory requirements.

For example only, if the array of price data was described as an ordered array based on the value timestamp of the price data such as by pseudocode “[{date: “Oct. 17, 2025 10:00:00”, price: 10000.00}, {date: “Oct. 17, 2025 10:00:10”, price: 10000.10}, {date: “Oct. 17, 2025 10:00:30”, price: 10010.10}]”, then the service processor 86 may iteratively process the price data in the array into the delta-encoded buffer of price data, such that the first price data (e.g., {date: “Oct. 17, 2025 10:00:00”, price: 10000.00}) is a key price data, the second price data (e.g., {date: “Oct. 17, 2025 10:00:10”, price: 10000.10}) is encoded as a first delta price data having a value of “{+10, +0.10}” (e.g., the difference between “date: “Oct. 17, 2025 10:00:00”” of the key value timestamp and “date: “Oct. 17, 2025 10:00:10”” of the value timestamp of the second price data as the first delta time and the difference between “price: 10000.00” of the key market value and “price: 10000.10” of the second market value as the first delta value), and the third price data (e.g., {date: “Oct. 17, 2025 10:00:30”, price: 10010.10}) is encoded as a second delta price data having a value of “{+20, +10.00}” (e.g., the difference between the second price data and the third price data), resulting in a delta-encoded buffer of price data of “[{date: “Oct. 17, 2025 10:00:00”, price: 10000.00}, {+10,+0.10}, {+20, +10.00}]”. In this example, the delta-encoded buffer of price data may be a second-type buffer, thus the delta time includes increments of less than 1 minute (e.g., in the order of seconds).

In this way, the array of price data can be recreated (e.g., delta-decoded) by selecting the key price data as a first delta-decoded price data and sequentially and iteratively calculating the remaining price data of the array by, for each delta price data, adding or combining the delta time with the prior delta-decoded value timestamp as the value timestamp of the respective price data and the delta value with the prior delta-decoded market value as the market value of the respective price data. For example, the second price data may be determined by delta-decoding the delta-encoded buffer of price data, such that the first price data is the key price data “{date: “Oct. 17, 2025 10:00:00”, price: 10000.00}” and the second price data is calculated as “Oct. 17, 2025 10:00:00” (i.e., the key value timestamp) summed with “+10” (i.e., the first delta time), resulting in a second value timestamp of {date:“Oct. 17, 2025 10:00:10”}, and “10000.00” (i.e., the key market value) summed with “+0.10” (i.e., the second delta value) resulting in a second market value of {price: 10000.10}. Thus, the second price data is delta-decoded as “{date: “Oct. 17, 2025 10:00:10”, price: 10000.10}”. In this embodiment, each delta price data is calculated as a difference between a particular price data in the array and a prior price data in the array.

In some embodiments, the service processor 86 delta-encoding at least the portion of the service buffer 95 of price data (step 540) may include providing multiple key price data periodically within the delta-encoded buffer of price data. For example only, every hundredth or every thousandth price data in the array of price data may be provided as a respective key price data. For a nonlimiting example, if 25,000 price data records are provided in the service buffer, the delta-encoded buffer of price data may include 25 key price data with each key price data being followed by 999 delta-encoded buffer of price data.

In other embodiments, each delta price data may be calculated as a difference between a particular price data in the array and the key price data. In this embodiment, recreating (e.g., delta-decoding) the array of price data from the delta-encoded buffer of price data may include selecting the key price data as a first delta-decoded price data and sequentially and iteratively calculating the remaining price data of the array by, for each delta price data, adding or combining the delta time with the key value timestamp to create the value timestamp of the respective price data and the delta value with the key market value to create the market value of the respective price data.

The backtesting system 10 solves the technical problem of large data transfers of the price data and a slow response to progression through the backtesting session by the service processor 86 delta-encoding the price data to significantly reduce an amount of data transmitted from the service device 22 to the user device 18 and significantly reducing the transfer time of the price data from the service device to the user device, thereby allowing user devices 18 to more quickly receive the price data to process and display on the primary user interface 30. Further, by maintaining the service buffer 95, the backtesting system 10 may further overcome the technical problems inherent in querying large corpus of data being a time-consuming process by buffering the price data in the service buffer such that when the user device 18 requests price data, the service processor 86 is not required to query the historical data after receiving the request and before being able to respond to the request. This arrangement enables the service device 22 to more quickly respond to the user device 18 without traditional delays.

The client processor 58, upon receiving the delta-encoded buffer of price data, may delta-decode the buffer of price data and store the delta-decoded buffer of price data in the client memory 66, such as with the client buffer 76 of the price data (step 548). The client processor 58 may then load or render the graph 304 of the historic market instrument 305 on the chart 302 of the primary user interface 30 displayed on the output device 54.

After returning the delta-encoded buffer of price data to the user device 18, the service processor 86 may query for one or more active order with one or more positions (step 552), e.g., from the service memory 82. The service processor 86 may then store the active orders in the service memory 82 (step 556), such as in an order manager cache. After storing the active orders in the service memory 82, the service processor 86 may emit an active-orders event 560 having the active orders and may emit a paginated-open-positions event 562 having the open positions. The service processor 86 may then query paginated closed positions (step 564), e.g., from the service memory 82 and emit a paginated-closed-positions event 568 having the paginated closed positions. Finally, the service processor 86 may emit a session-summary event 572. The session-summary event 572 may include, for example, session-summary data including a ticker step, the increment value selected from the increment selector 342, backtesting session data (including the current session time), and statistics regarding the backtesting session. The statistics may include, for example, backtesting session data, financial instrument data, current account balance, realized profit and loss, unrealized profit and loss, status of the session, and the like, or combinations thereof, for example. In step 588, the statistics may be shown or rendered, for example, in the session-summary section 326 of the primary user interface 30 (shown in FIG. 4B).

In one embodiment, the client processor 58, receiving the active-orders event 560 may render the active orders in the chart 302 (step 576). Further, upon receiving the paginated-open-positions event 562, the client processor 58 may render the positions table 332 on the primary user interface 30 (step 580) to include the retrieved open positions.

In one embodiment, the client processor 58, receiving the paginated-closed-positions event 568 may render the paginated closed positions in the primary user interface 30, such as in the positions table 332, upon selection of the closed positions input 333b (FIG. 4B).

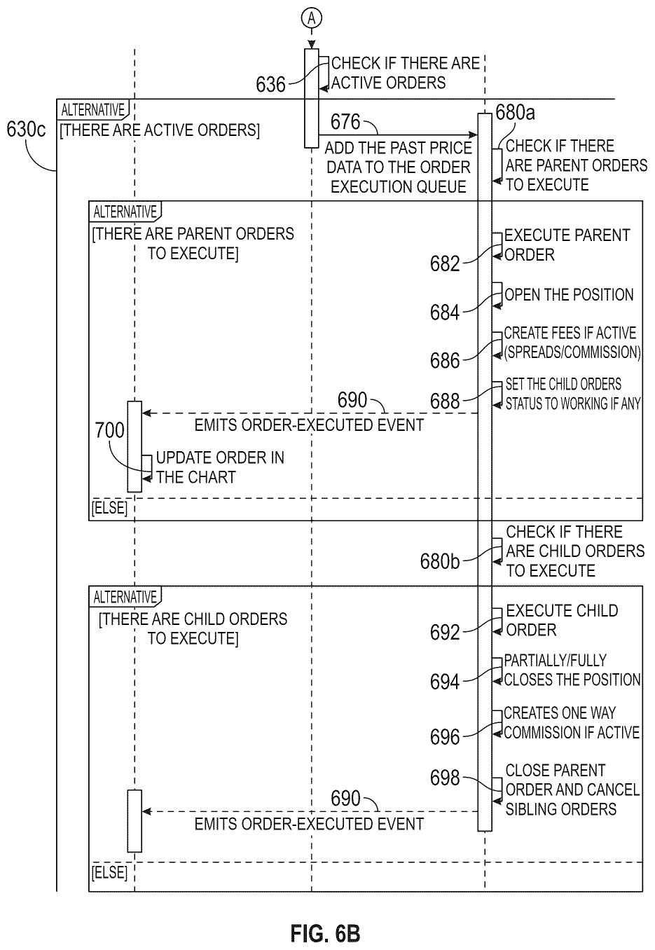

Referring now to FIGS. 6A-6B, in combination, shown therein is a diagram of an exemplary embodiment of a session-service update process 600 constructed in accordance with the present disclosure. The client processor 58 may receive an input from the input device 50, such as: by selection of one or more of: a goto input such as the goto jump under the Goto option 316g (FIG. 4B), a play input such as a play button 340 (FIG. 4B), and a skip input such as a skip-forward button 344 (FIG. 4B); by input of a key, key press, or key combination (e.g., from a keyboard, such as, by way of example and not limitation, a space bar, or a combination of key presses, such as, by way of example and not limitations, pressing the control key and the space bar); and by interaction with the graph 304 such as selection of a candlestick of the historic market instrument 305 on the graph 304, and/or the like; by the user 14 in the primary user interface 30.

As shown in FIG. 6A, when the client processor 58 receives the input from the input device 50 (step 604), the client processor 58 of the user device 18 executing the user application 74 may iteratively: update the simulation time 310 from the simulation time to a target time (step 608); move forward the simulation time 310 to the target time in the chart 302 by loading price data from the client buffer 76 corresponding to price data having the price timestamp equal or prior to the target time (step 612); and remove the loaded price data from the client buffer 76 (step 616). For each iteration increasing the simulation time 310 by the time increment, the client processor 58 may emit an update-time event with the target time and (optionally) a backtesting session ID as a parameter (event 620). Upon receiving an indication of a selection of an increment value within the increment selector 342, the client processor 58 may store the selected increment value with the backtesting session data. In some embodiments, the client processor 58 may only emit the update-time event with the target time if the backtesting session ID of the particular backtesting session instance in which the input to the primary user interface 30 was received is the session manager of the backtesting session.

The service processor 86 may receive the update-time event with the target time and may update a current session time stored in the service memory 82 and remove price data having the price timestamp of or prior to the current session time (step 624). The service processor 86 may receive the update-time event with the target time and may update the current session time stored in the service memory 82 if the backtesting session ID of the update-time event is the session manager. The service processor 86 may then check for price data in the service buffer 95 (step 628) to determine whether to execute a first subprocess 630a, check a length of the price data in the service buffer 95 (step 632) to determine whether to execute a second subprocess 630b, and check for active orders (step 636) to determine whether to execute a third subprocess 630c.

If the service processor 86 determines that there is no remaining price data in the service buffer 95 at step 628, the service processor 86 may execute the first subprocess 630a to may emit an end-reached event 640 and exit the session-service update process 600.

If the service processor 86 determines that the length of the price data in the service buffer 95 (from step 632) is at or below a minimum buffer length, the service processor 86 may execute the second subprocess 630b. Upon execution of the second subprocess 630b, the service processor 86 may query historical data for the financial instrument (step 644) and may, (optionally, simultaneously) emit a buffering event 648. The service processor 86 may query the historical data from the service memory 82, for example, such as from the second database 94b storing the historical data until the service buffer 95 reaches the predetermined maximum buffer length. For example, the predetermined maximum buffer length may be between about 25,000 records and 50,000 records. It should be understood that a person having ordinary skill in the art may select the predetermined maximum buffer length different from between 25k records and 50k records based on, for example, hardware limitations and performance expectations. Similarly, the minimum buffer length may be a predetermined minimum buffer length. The minimum buffer length may be between, for example, 10,000 records and 30,000 records and may depend on the selection of the predetermined maximum buffer length. In some embodiments, the minimum buffer length may be selected to be between about 20% and 60% of the maximum buffer length.

The service processor 86 may determine a length of the price data in the service buffer 95 and may query a particular set of price data records from the historical data based on a difference between the length and the maximum buffer length, such that the queried price data includes subsequent price data, i.e., price data having a price timestamp immediately subsequent to the greatest price timestamp of the price data in the service buffer 95.

The service processor 86, upon receiving the queried price data may include the price data in the service buffer 95 of price data (step 652), such as by concatenating the queried price data to the service buffer 95, and may emit a buffering-end event 656. Upon receiving a buffer request for a subsequent buffer of price data, the service processor 86 may delta-encode the requested buffer of price data (step 660) and may return the delta-encoded buffer to the requestor (step 664). In one embodiment, the service processor 86 may further include the current session time with the delta-encoded buffer in response to the request of the buffer of price data. In other embodiments, the service processor 86 may further include the backtesting session data for the backtesting session with the delta-encoded buffer in response to the request of the buffer of price data.

The client processor 58, receiving the buffering-end event 656, may send the buffer request to the service device, the buffer request requesting the subsequent buffer of price data for the financial instrument of the backtesting session (step 668). In one embodiment, upon receiving the delta-encoded buffer, the client processor 58 may delta-decode and store the subsequent buffer of price data in the client buffer 76 (step 672), such as by concatenating the received buffer of price data with the client buffer of price data. In other embodiments, upon receiving the delta-encoded buffer, the client processor 58 may delta-decode and store the buffer of price data in the client buffer 76 (step 672) by replacing the price data in the client buffer with the delta-decoded buffer of price data.

In one embodiment, if the backtesting instance ID of the particular backtesting session receiving the buffer of price data is not the session manager of the backtesting session, the client processor 58 may update the simulation time 310 based on the received current session time.

If the service processor 86 determines that there are active orders (from step 636), the service processor 86 may execute the third subprocess 630c. Upon execution of the third subprocess 630c, the service processor 86 may add past price data to an order execution queue (step 676). The service processor 86 may then check for parent orders (step 680a) and check for child orders (step 680b). Each parent order may be, for example, a buy/sell order to open a position and may include one or more child orders. Each child order may be, for example, a take profit/stop loss, which helps to manage the parent order. Child orders sharing a parent order, e.g., having a common parent order, may be related to one another as sibling orders.

In one embodiment, upon determining that there are parent orders to execute in step 680a, the service processor 86 may execute the parent order (step 682), open the position (step 684), create fees (step 686), set child orders status to working (step 688) and emit an order-executed event 690 having order data, such as parameters indicative of one or more of: the parent order, the child orders, the fees (if applicable), and the opened position.

In one embodiment, the service processor 86 may only create the fees (step 686) if the user 14 has activated fees calculations. The service processor 86 may determine whether the user 14 has activated fees calculations based on the calculate fees option of the backtesting session data for the backtesting session. In some embodiments, the user 14 may select the calculate fees option when creating a backtesting session. In other embodiments, the user 14 may select the calculate fees option as part of the account information for the user's user account. The created fees may include, for example, one or more of: spreads, commissions, one-way commissions, and the like, or combinations thereof.

In one embodiment, the client processor 58 may receive the order-executed event 690 and may update the primary user interface 30 based on the executed parent order (step 700). For example, the client processor 58 may add the position opened in step 684 to the positions table 332 (if the positions table 332 is displaying open positions, for example).

In one embodiment, upon determining that there are child orders to execute in step 680b, such as by identifying active child orders, the service processor 86 may execute the active child order (step 692), close the position (step 694), create commission (step 696), close family orders (step 698), and emit the order-executed event 690 having order data, such as parameters indicative of one or more of: the child order, parent order, the fees (if applicable) and the closed position. In one embodiment, closing the position (step 694) may include the service processor 86 either partially or fully closing the position. In this way, if a parent order is open, and if child orders are active then when the simulation time advances and the price of the financial instrument reaches a point where the child orders can execute, the open position may be partially or completely closed.

In one embodiment, closing the family orders (step 698) may include the service processor 86 closing the parent order of the child order and cancelling sibling orders (e.g., other child orders of the parent order).

In one embodiment, the client processor 58 may receive the order-executed event 690 and may update the primary user interface 30 based on the executed child order (step 700). For example, the client processor 58 may add the position closed in step 694 to the positions table 332 (if the positions table 332 is displaying closed positions, for example). In one embodiment, the client processor 58 may further move a position from the open positions to closed positions in response to the order-executed event 690 generated after closing the position (step 694) and closing the family orders (step 698). The client processor 58 may further remove the parent order from the chart 302, remove all child orders from the chart 302, and render the closed position on the positions table 332.

In one embodiment, one or more of the events emitted by the service processor 86 may include the current session time as a property. The client processor 58, receiving the emitted event may update the simulation time 310 of the backtesting session in the primary user interface 30 when the backtesting session instance in the primary user interface 30 is not the session manager.

### CONCLUSION

The foregoing description provides illustration and description, but is not intended to be exhaustive or to limit the inventive concepts to the precise form disclosed. Modifications and variations are possible in light of the above teachings or may be acquired from practice of the methodologies set forth in the present disclosure.

From the above description, it is clear that the inventive concept(s) disclosed herein are well adapted to carry out the objects and to attain the advantages mentioned herein, as well as those inherent in the inventive concept(s) disclosed herein. While the embodiments of the inventive concept(s) disclosed herein have been described for purposes of this disclosure, it will be understood that numerous changes may be made and readily suggested to those skilled in the art which are accomplished within the scope and spirit of the inventive concept(s) disclosed herein.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred embodiment. Further, the phrase “based on” is intended to mean “based, at least in part, on” unless explicitly stated otherwise.

1. A backtesting system, comprising:
a user device having an input device, an output device, a client processor, and a client memory, the client memory comprising a first non-transitory processor-readable medium storing processor-executable instructions that when executed by the client processor, cause the client processor to:
display a primary user interface on the output device, the primary user interface operable to receive one or more input from the input device;
receive an input from a user indicative of selection of a backtesting session, the backtesting session associated with backtesting session data, the backtesting session data associated with at least one financial instrument;
send an initialization signal to a service device to cause the service device to initialize an event-based communication session, the initialization signal including at least a user ID and a backtesting session ID;
request a buffer of price data for the at least one financial instrument, the buffer of price data having at least a buffer start timestamp, the price data for each financial instrument comprises at least a price timestamp and an instrument value;
delta-decode a received delta-encoded buffer of price data as the buffer of price data and store the buffer of price data in the client memory; and
render, in a backtesting chart of the primary user interface, the price data for the at least one financial instrument corresponding to a simulation time; and
the service device comprising a service processor and a service memory, the service memory comprising a second non-transitory processor-readable medium storing processor-executable instructions that when executed by the service processor, cause the service processor to:
establish the event-based communication session with the user device based on the initialization signal;
retrieve backtesting session data based on the backtesting session ID of the initialization signal;
select historical data for each financial instrument in the backtesting session and store the historical data in a memory buffer;
in response to the request for the buffer of price data, delta-encode the buffer of price data based on the historical data for each financial instrument and the buffer start timestamp to generate the delta-encoded buffer of price data having at least one key price data and a plurality of delta price data; and
transmit the delta-encoded buffer of price data.

2. The backtesting system of claim 1, wherein the service memory further comprises instructions that cause the service processor to:
determine one or more active orders with one or more open positions based on the backtesting session ID, the one or more active orders being an active order of the one or more financial instrument;
store the one or more active orders in an order manager cache; and
emit an active-orders event comprising the one or more active orders; and
wherein the client memory further comprises instructions that cause the client processor to:
render the one or more active orders in the backtesting chart based on the active-orders event.

3. The backtesting system of claim 2, wherein the service memory further comprises instructions that cause the service processor to:
emit a paginated-open-positions event comprising the one or more open positions of the one or more active orders; and
wherein the client memory further comprises instructions that cause the client processor to:
render the one or more open positions in an open positions table within the primary user interface.

4. The backtesting system of claim 1, wherein the service memory further comprises instructions that cause the service processor to:
determine one or more closed positions of the one or more financial instruments based on the backtesting session ID; and
emit a paginated-closed-positions event comprising the one or more closed positions; and
wherein the client memory further comprises instructions that cause the client processor to:
render the one or more closed positions in in a closed positions table within the primary user interface based on the paginated-closed-positions event.

5. The backtesting system of claim 4, wherein the service memory further comprises instructions that cause the service processor to:
emit a session-summary event for the backtesting session, the session-summary event including session-summary data and a current session time, the session-summary data including at least one of: a ticker step, a current account balance, a realized profit and loss, and an unrealized profit and loss; and
wherein the client memory further comprises instructions that cause the client processor to:
render a session-summary section within the primary user interface in response to the session-summary event, the session-summary section displaying at least a portion of the session-summary data; and
update the simulation time based on the current session time.

6. The backtesting system of claim 1, wherein the instruction to cause the service processor to delta-encode the buffer of price data, further includes instructions to cause the service processor to:
in response to the request for the buffer of price data, delta-encode the buffer of price data, the buffer of price data including the price data for each financial instrument having respective price timestamps of, or subsequent to, the buffer start timestamp, the buffer of price data having a number of price data records within a predetermined maximum buffer length.

7. The backtesting system of claim 6, wherein the predetermined maximum buffer length is between about 25,000 price data records and 50,000 price data records.

8. The backtesting system of claim 1, wherein the buffer start timestamp is after the simulation time.

9. The backtesting system of claim 1, wherein the rendered price data does not include price data having respective price timestamps after the simulation time.

10. A backtesting system, comprising:
a user device having an input device, an output device, a client processor, and a client memory, the client memory comprising a first non-transitory processor-readable medium storing a first delta-decoded buffer of price data having a buffer start timestamp, the price data comprising at least a price timestamp and an instrument value for at least one financial instrument, and processor-executable instructions that when executed by the client processor, cause the client processor to:
display a primary user interface on the output device for a backtesting session, the primary user interface operable to receive one or more input from the input device, the backtesting session having a first simulation time and a backtesting chart for the at least one financial instrument;
receive an input from the input device;
increment the first simulation time to a second simulation time by a time increment and load the price data having a price timestamp within a range of the first simulation time and the second simulation time, and remove the loaded price data from the first delta-decoded buffer of price data;
emit an update-time event having the second simulation time as a parameter; and
render, in a backtesting chart of the primary user interface, the loaded price data for the at least one financial instrument corresponding to the second simulation time; and
a service device comprising a service processor and a service memory, the service memory comprising a second non-transitory processor-readable medium storing a current session time for the backtesting session, a second buffer of the price data, a historical data database, and processor-executable instructions that when executed by the service processor, cause the service processor to:
receive the update-time event having the second simulation time;
update the current session time for the backtesting session to the second simulation time; and
remove price data for the at least one financial instrument having respective price timestamps before the current session time.

11. The backtesting system of claim 10, wherein the client memory further comprises instructions that cause the client processor to:
responsive to receiving a buffering-end event:
request a subsequent buffer of price data for the at least one financial instrument as a buffer request to the service device; and
delta-decode a delta-encoded buffer of price data into the subsequent buffer of price data and combine the subsequent buffer of price data with the first delta-decoded buffer of price data in the client memory; and
update the backtesting chart of the primary user interface with the price data for the at least one financial instrument corresponding to the second simulation time; and
wherein the service memory further comprises instructions that cause the service processor to:
responsive to identifying the second buffer has a length less than a minimum buffer length:
query subsequent price data from the historical data database for the at least one financial instrument to fill the second buffer to a maximum buffer length;
update the second buffer to further include the subsequent price data; and
emit the buffering-end event indicative of completion of the update to the second buffer; and
responsive to receiving the buffer request from the user device:
delta-encode the second buffer of price data as the delta-encoded buffer of price data; and
return the delta-encoded buffer of price data to the user device.

12. The backtesting system of claim 10, wherein the service memory further comprises instructions that cause the service processor to:
determine one or more active orders based on a backtesting session ID of the backtesting session, the one or more active orders being either a parent order or a child order;
for each parent order, execute the parent order and store order data indicative of the parent order;
open a position for the parent order and update the order data to include the position;
create first fees based on the executed parent order as part of the order data;
mark each child order of the parent order as working; and
emit an order-executed event having the order data; and
wherein the client memory further comprises instructions that cause the client processor to:
render each executed parent orders in the backtesting chart based on the order data of the order-executed event.

13. The backtesting system of claim 12, wherein the order-executed event is a first order-executed event, and the service memory further comprises instructions that cause the service processor to:
for each child order marked as working, execute the child order and store order data indicative of the child order;
close the position for the child order and update the order data to include the position;
create second fees based on the executed child order as part of the order data;
close the child order and cancel sibling orders, sibling orders being active child orders having a common parent order; and
emit a second order-executed event having the order data; and
wherein the client memory further comprises instructions that cause the client processor to:
render the executed child order in the backtesting chart based on the order data of the second order-executed event.

14. The backtesting system of claim 13, wherein the instructions to close the position for the child order includes one of: partially close the position for the child order, and fully close the position of the child order.

15. The backtesting system of claim 12, wherein the first fees include one or more of a spread and a commission.

16. The backtesting system of claim 12, wherein the backtesting session further includes a calculate fees option, and wherein the service memory further comprises instructions that cause the service processor to:
create the first fees based on the executed parent order as part of the order data responsive to a second input indicative of selection of the calculate fees option.

17. The backtesting system of claim 10, wherein the service memory further comprises instructions that cause the service processor to:
responsive to the query for subsequent price data from the historical data database for the financial instrument returning zero results, emitting an end-reached event; and
wherein the client memory further comprises instructions that cause the client processor to:
responsive to receiving the end-reached event, render a session-summary section within the primary user interface.

18. The backtesting system of claim 10, wherein the input from the input device includes selection of one or more of a play input, a goto input, and a skip input.
